(19) United States
(12) Patent Application Publication
(10) Pub. No.: US 2026/0006461 A1
(43) Pub. Date: Jan. 1, 2026

(54) METHOD AND SYSTEM TO COORDINATE AGENTS AND AVOID CONFLICTS

(71) Applicant: Telefonaktiebolaget LM Ericsson (publ), Stockholm (SE)

(72) Inventors: Julien FORGEAT, San Jose, CA (US); Maxime BOUTON, Stockholm (SE); Hasan FAROOQ, Santa Clara, CA (US); Jean Paulo MARTINS, Indaiatuba (BR); Shruti BOTHE, Santa Clara, CA (US)

(73) Assignee: Telefonaktiebolaget LM Ericsson (publ), Stockholm (SE)

(21) Appl. No.: 18/992,344

(22) PCT Filed: Jul. 11, 2022
(86) PCT No.: PCT/IB2022/056401

§ 371 Date: Jan. 8, 2025

(51) Int. Cl. H04W 24/02

(52) U.S. Cl. CPC H04W 24/02

(57) ABSTRACT

A method is provided for coordinating nodes in a radio access network to optimize radio network operations. The method includes obtaining a topology of a plurality of network nodes in the radio access network. The method includes obtaining, for each network node of the plurality of network nodes, a plurality of potential actions each network node can perform in the radio access network to optimize one or more radio network operations. The method includes obtaining, for each network node of the plurality of network nodes, an optimization function. The method includes determining an action from the plurality of potential actions for a first network node of the plurality of network nodes to perform based on the plurality of potential actions and an optimization function.

### TECHNICAL FIELD

Disclosed are embodiments related to coordinating nodes in a radio access network to optimize radio network operations.

### INTRODUCTION

Mobile cellular telecommunication networks, referred to herein as “mobile networks,” are large networks encompassing a large number of computing devices to enable mobile devices that connect wirelessly to the mobile network to communicate with other computing devices including both other mobile devices and other types of computing devices. The mobile devices, e.g., user equipment (UE) such as mobile phones, tablets, laptops, and similar devices, may frequently travel and shift connection points with the mobile network in a manner that maintains continuous connections for the applications of the mobile devices. Typically, the mobile devices connect to the mobile network via radio access network (RAN) base stations, which provide connectivity to any number of mobile devices for a local area or ‘cell.’ Managing and configuring the mobile network including the cells of the mobile network is an administrative challenge as each cell can have different geographic and technological characteristics.

In some instances, multiple agents (such as network nodes in a mobile network) may take conflicting actions when attempting to implement an intent. For example, the intent could be to have a mobile network minimize energy consumption while maintaining a certain level of coverage quality, and conflicting agents could be: (1) a self-organizing network (SON) cell-shaping agent limiting the transmission power of an antenna to reduce energy consumption; (2) a core network agent downscaling a network function (NF) like a mobility management entity (MME) to lower the power bill; and/or (3) a network slicing agent turning on indoor sites on a facility following prediction of unusual activity in a business park that is typically not busy at the time. Potential resulting conflicts could be that turning on the sites in [3] increases load on the network function in [2] ultimately breaking some service-level agreements (SLAs), or the combination of low power in [1] and turned-on sites in [3] increasing the quantity of handovers resulting in a load increase in the network functions in [2].

In an uncoordinated automated network, a variety of conflicts may occur when: (1) Two or more agents try to modify the same network configuration parameter in opposite directions or when one agent modifies a large increment or decrement in a network parameter, while the second agent modifies only small increment or decrement for the same network parameter; or (2) Different agents try to alter the same key performance indicator (KPI) of a network, while adjusting different network configuration parameters of same or different domains. Since these agents reside in different domains (e.g., different operators), it is challenging to have them coordinate their actions. The operator could be using different vendors for its SON agents, core network agents and/or slicing agents. These agents can also be managed and operated by different departments within the operators, which makes coordination difficult.

### SUMMARY

Aspects of the present disclosure are designed to make coordination easier among agents, such as network nodes in a RAN. In some embodiments, a standard way is provided to measure the quality of a pair of actions from two potentially interfering agents. In some examples, an optimization function may be provided that takes an action from agent (1) (e.g., a new power level for antenna) and an action from agent (2) (e.g., a new number of instances deployed for the NF) as input and returns a scalar. The returned scalar may be higher if the supplied pair of actions is not conflicting, that's to say if action 1 will not impede action 2 and vice-versa. These functions may be referred to herein as edge value functions, or value functions (“VF”) for short, and more generally as an optimization function.

In some embodiments, an algorithm is provided that leverages these value functions and provides for a way for an agent to pick an action that is not only locally optimum but, through a coordination mechanism, allows the agent to pick an action that is good for itself while not conflicting with other agents in the network. This coordination process can be run in a completely decentralized way with agents directly communicating with each other or in a centralized way where an arbitrator is able to add another layer of decision or deal with incomplete data (for example if a given pair of agents does not have a VF). Continuing with the example above, before choosing by how much it should reduce power, agent (1) would trigger a coordination computation across agents that are within its area of influence which would result in an action that is aware of the needs of agents (2) and (3).

According to one aspect, a computer-implemented method for coordinating nodes in a radio access network to optimize radio network operations is provided. The method includes obtaining a topology of a plurality of network nodes in the radio access network. The method includes obtaining, for each network node of the plurality of network nodes, a plurality of potential actions each network node can perform in the radio access network to optimize one or more radio network operations. The method includes obtaining, for each network node of the plurality of network nodes, an optimization function. The method includes determining an action from the plurality of potential actions for a first network node of the plurality of network nodes to perform based on the plurality of potential actions and an optimization function.

In some embodiments, the optimization function and the plurality of potential actions are the same for each network node of the plurality of network nodes. In some embodiments the method further includes determining that the action maximizes an optimization function of the first network node.

In some embodiments, the plurality of potential actions are the same for each network node of the plurality of network nodes, and an optimization function of the first network node is different than an optimization function of a second network node of the plurality of network nodes. In some embodiments, the method further includes generating an aggregated optimization function using each optimization function from each network node, and determining that the action maximizes the aggregated optimization function. In some embodiments, the aggregated optimization function comprises at least one of: a sum of each optimization function from each network node, a weighted sum of each optimization function from each network node, a parametric function of each optimization function from each network node using a learned parameter, or a combination thereof.

In some embodiments, the optimization function is the same for each network node of the plurality of network nodes, and a first plurality of potential actions of the first network node is different than a second plurality of potential actions of a second network node of the plurality of network nodes. In some embodiments, the topology is a coordination graph comprising a plurality of vertices corresponding to a respective network node of the plurality of network nodes and at least one edge connecting two of the vertices of the plurality of vertices, wherein each edge in the coordination graph indicates that an action of a network node corresponding to a first vertex connected to the edge may interfere with an action of a network node corresponding to a second vertex also connected to the edge. In some embodiments, a first vertex corresponds to the first network node and a second vertex corresponds to the second network node, and a first edge connects the first vertex to the second vertex. In some embodiments, a first optimization function of the first network node returns a value for each pair of actions taken by the first network node and the second network node. In some embodiments, the method further includes, for a respective network node of the plurality of network nodes: (i) identifying any neighboring network nodes to the respective network node based on the coordination graph, (ii) for each neighboring network node identified in step (i), computing a first message corresponding to a first maximum payoff that the respective network node can achieve if the neighboring network node takes a specified action, (iii) transmitting the first message towards each neighboring network node, and (iv) receiving, from each neighboring network node, a second message, indicating a second maximum payoff that the neighboring network node can achieve if the respective network node takes a second specified action. In some embodiments the method further includes, for each respective network node of the plurality of network nodes: (v) for each neighboring network node, computing a third message corresponding to an updated first maximum payoff that the respective network node can achieve if the neighboring network node takes a third specified action based on the second maximum payoff indicated in the second message, (vi) transmitting the third message towards each neighboring network node, and (vii) receiving, from each neighboring network node, a fourth message, indicating an updated second maximum payoff that the neighboring network node can achieve if the respective network node takes a fourth specified action. In some embodiments, the method further includes repeating steps (i)-(vii) until convergence of the first maximum payoff and the second maximum payoff or a predetermined number of times.

In some embodiments, a first optimization function of the first network node is different than a second optimization function of a second network node of the plurality of network nodes, and a first plurality of potential actions of the first network node is different than a second plurality of potential actions of the second network node. In some embodiments, the method further includes identifying a first set of one or more network nodes of the plurality of network nodes having the first optimization function; constructing, using the topology, a first coordination graph comprising a plurality of vertices corresponding to a respective network node of the first set of one or more network nodes and at least one edge connecting two of the vertices of the plurality of vertices, wherein each edge in the first coordination graph indicates that an action of a network node corresponding to a first vertex may interfere with an action of a network node corresponding to a second vertex; identifying a second set of one or more network nodes of the plurality of network nodes having the second optimization function; and constructing, using the topology, a second coordination graph comprising a plurality of vertices corresponding to a respective network node of the second set of one or more network nodes and at least one edge connecting two of the vertices of the plurality of vertices, wherein each edge in the second coordination graph indicates that an action of a network node corresponding to a first vertex may interfere with an action of a network node corresponding to a second vertex. In some embodiments, the method further includes computing, for each edge in the first coordination graph, a joint optimization function; and computing, for each edge in the second coordination graph, a joint optimization function. In some embodiments, the method further includes generating an aggregated optimization function based on a plurality of joint optimization functions from at least one of the first coordination graph and the second coordination graph; and determining an action from the plurality of potential actions that maximizes the aggregated optimization function. In some embodiments, the aggregated optimization function comprises at least one of: a sum of the plurality of joint optimization functions, a weighted sum of the plurality of joint optimization functions, a parametric function of the plurality of joint optimization functions using a learned parameter, or a combination thereof.

In some embodiments, the one or more radio network operations comprise one or more of: reducing energy consumption, limiting transmission power of an antenna, downscaling a network function, turning on indoor sites on a facility, incrementing or decrementing a network parameter, adjusting a key performance indicator of the network, achieving a target signal-to-interference-plus-noise ratio (SINR) value for all user equipment connected to an antenna, improving coverage for user equipment served by an antenna, maximizing throughput, or maximizing coverage.

In some embodiments, the method further includes determining a respective action from the plurality of potential actions for each of the plurality of network nodes to perform based on the plurality of potential actions and an optimization function.

In another aspect there is provided a device with processing circuitry adapted to perform the methods described above. In another aspect there is provided a computer program comprising instructions which when executed by processing circuitry of a device causes the device to perform the methods described above. In another aspect there is provided a carrier containing the computer program, where the carrier is one of an electronic signal, an optical signal, a radio signal, and a computer readable storage medium.

### BRIEF DESCRIPTION OF THE DRAWINGS

The accompanying drawings, which are incorporated herein and form part of the specification, illustrate various embodiments.

FIG. 1 illustrates a radio access network, according to some embodiments.

FIG. 2 is a block diagram of a coordination scenario in a radio access network, according to some embodiments.

FIGS. 3A-B are block diagrams of a coordination scenario in a radio access network, according to some embodiments.

FIG. 4 is a block diagram of a coordination scenario in a radio access network, according to some embodiments.

FIG. 5 illustrates a method, according to some embodiments.

FIG. 6 is a block diagram of a device, according to some embodiments.

### DETAILED DESCRIPTION

Aspects of the present disclosure relate to coordination of nodes in a radio access network to optimize radio network operations, such as by finding optimal actions to satisfy an intent while minimizing conflicts among nodes.

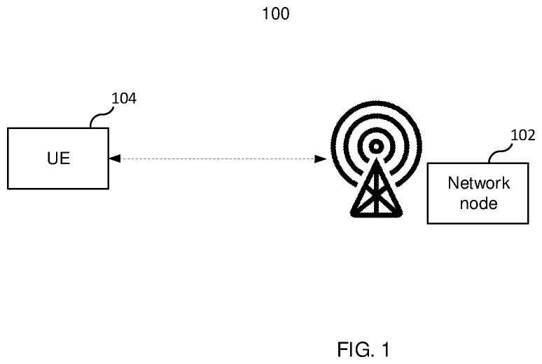

FIG. 1 illustrates a radio access network (100), according to some embodiments. The RAN may include a network node (102), which may optionally be serving a UE (104). While only one network node (102) and UE (104) is shown in FIG. 1 for simplicity, a person of skill would understand that the RAN (100) may include many UEs and network nodes.

The following terminology may be used herein.

Agent: a software entity that can fulfill an intent by interacting with the environment.

Action space: for a given agent, the set of possible actions it can take to fulfill an intent.

Objective: the objective that an agent is trying to reach by interacting with the environment through an action. Objective may be mapped one on one with intents.

With the above terminology, an example can be considered with a SON cell shaping agent that interacts with an antenna. The action space is a set of actions containing the set of possible tilt values for the antenna and the set of possible power levels for the antenna. The objective the agent is capable of reaching is a target average SINR for all the UEs connected to the antenna, and the intent it is capable of fulfilling would be to improve coverage for UEs served by the antenna. Note: for simplicity, agents are presented as only being able to achieve one objective (and therefore one intent), but it is possible to logically split more complex agents into single objective ones to generalize.

In some embodiments, knowledge about which agents can influence each other is provided. In some embodiments, agents may reside in completely different departments in the operator and still influence each other. According to some embodiments, a graph is needed in which each agent is a vertex and in which an edge is added between two vertices if their action can interfere on each other (or at least in one direction). This graph may be referred to herein as a network topology. In some embodiments, this graph is provided but it could be automatically built based on historical data (e.g., by observing what agents' states are altered when a given agent takes an action) while leveraging some metadata associated to the agents for example, geolocation of the physical hardware they control.

### Value Functions/Optimization Functions

In some embodiments, a value function or functions for a pair of agents may be provided. According to some embodiments, the term “value” is used herein to designate a scalar evaluating how good or bad the current network parameters are. The value of the network may be equal to the sum of the value of all the agents. The value of each agent or pair of agents can be a function of network KPIs and costs of operation. The value of an agent can be a function of its actions, that is, each action of an agent or pair of agents is associated to a scalar number. These functions may be needed for the computations to be performed as described herein, and it may be up to agent vendors and operators to provide them.

For any given agent or pair of agents, these VFs can be: (1) learned (one example of a learned VF using reinforcement learning is described more fully in PCT/IB2020/061668, “Decentralized coordinated reinforcement learning for optimizing radio access networks,” filed on Dec. 9, 2020, and hereby incorporated by reference in its entirety); (2) populated by domain experts; (3) agreed upon between two agent vendors; (4) in a case where the coordination algorithm is to be run centrally, a central service can take an arbitrator role and assign a value function to a pair of agents; or (5) any combination of these options. It is possible for these functions to be further tuned to better fit the deployed agents.

Mathematically, a value function or optimization function of an agent or of a pair of agents is a function that takes the possible actions taken by the agent(s) as input and returns a scalar. For single agent i: qᵢ(aᵢ, opt₁, . . . , optₙ) where: aᵢ is the action to be taken by agent i, and opt₁, . . . optₙ are optional arguments to be provided to the value function. For a pair of agents i and j: qᵢⱼ(aᵢ, aⱼ, opt₁, . . . , optₙ) where (in addition): aⱼ is the action to be taken by agent j. The set of optional arguments depends on the way the value function is implemented. It often includes parameters modelling the state observed by the agent. Note that in a case of agents provided by competing vendors, the vendors do not need to disclose any critical detail about how their agents are working, all they need to expose is the action space of their agents.

### Agent Coordination Process

The following paragraphs describe how the coordination process works over use-cases of increasing complexity.

### Single Agent/Single Action Space/Single Objective

In this scenario, multiple agents share the same action space A and the same objective. The goal is to choose the best agent-action. An example of this scenario would be: the objective is to lower the power consumption of the network; each agent can reduce power consumption by controlling the emitted power of one antenna; and the action space of the agents is a set of possible power levels for the antenna. It may be assumed that each agent i=1, . . . , n, has its state-action value function, qᵢ(a) which quantifies the expected future benefits achievable by choosing action a

Since all agents share the same objective and action space A, it is reasonable to consider that the best action a* maximizes the value functions as follows:

$${a}^{*} = arg {max}_{a ∈ A} {q}_{i} ( a ) ,$$

i=1, . . . , n.

### Multiple Agents/Single Action Space/Multiple Objectives

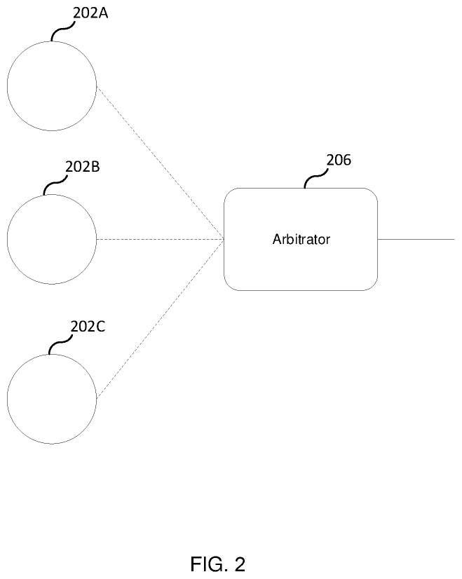

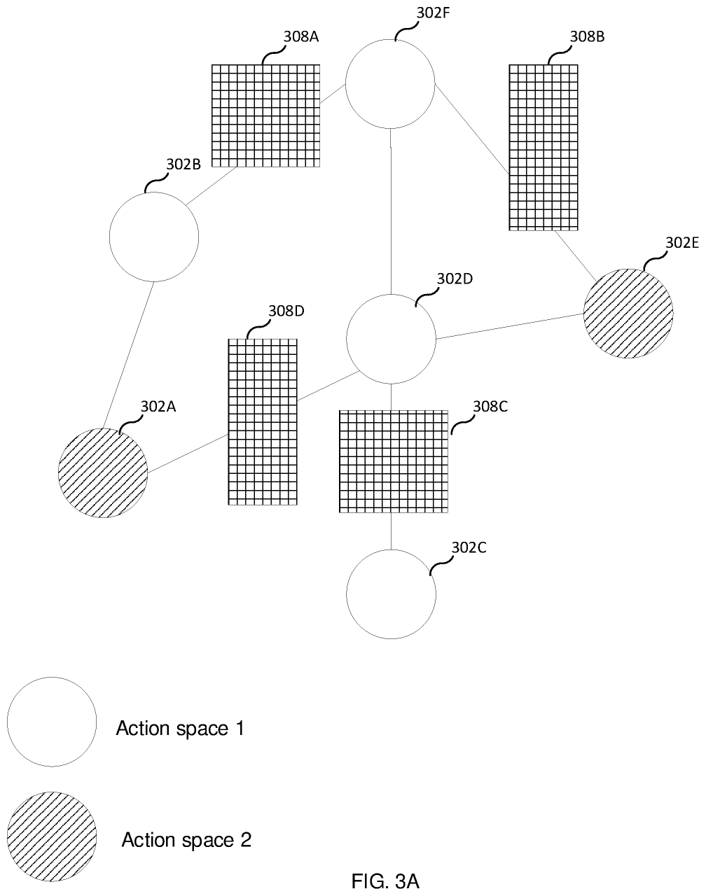

FIG. 2 is a block diagram of a coordination scenario in a radio access network, according to some embodiments. FIG. 2 illustrates a RAN network with a plurality of network nodes (202A-C) in communication with an arbitrator (206). In this example, each network node (202A-C) is an agent, there is a single action space, and multiple objectives.

In this scenario, multiple agents (202A-C) share the same action space but have different objectives. An example of this scenario would be: the agents are a set of agents with multiple objectives, such as an agent trying to maximize throughput and an agent trying to maximize coverage; the action is to control the tilt of an antenna; all agents act on the same parameter and must agree on the best tilt value.

Let A be the shared action space by all the agents. At a given state, each agent i will provide a value function (a) V aEA. For discrete action spaces, this value function is typically a vector of the size of the action space. Each element of the vector indicates how much agent i values action a with respect to its own objectives.

Obtaining the individual value function can be done through Markov decision processes (MDP) planning, Reinforcement Learning, expert knowledge, control theory, or any other methods as would be appreciated by a person of skill in the art. The value function provides a metric to compare how much each agent values the actions.

In order for the agents to agree on the action to select, an arbitrator is responsible for aggregating the individual value functions. The aggregation method can be as simple as a sum:

$$q ( a ) = {\sum }_{i} q ( a ) ∀ a ∈ A .$$

More generally, any combination of the individual value functions is acceptable: q(a)=f(q₁(a), . . . , qₙ(a)). Possible candidates for f are: a weighted sum with predefined weight, a parametric function with learned parameter (e.g., from a neural network (NN)), but also ordering strategies based on a predefined prioritization of the objective.

Once the individual value functions for each agent (202A-C) have been aggregated, the arbitrator (206) selects the best action. In some embodiments, the arbitrator (206) selects the best action according to

$${a}^{*} = arg {max}_{a ∈ A} q ( a ) .$$

### Multiple Agents/Multiple Action Spaces/Single Objective

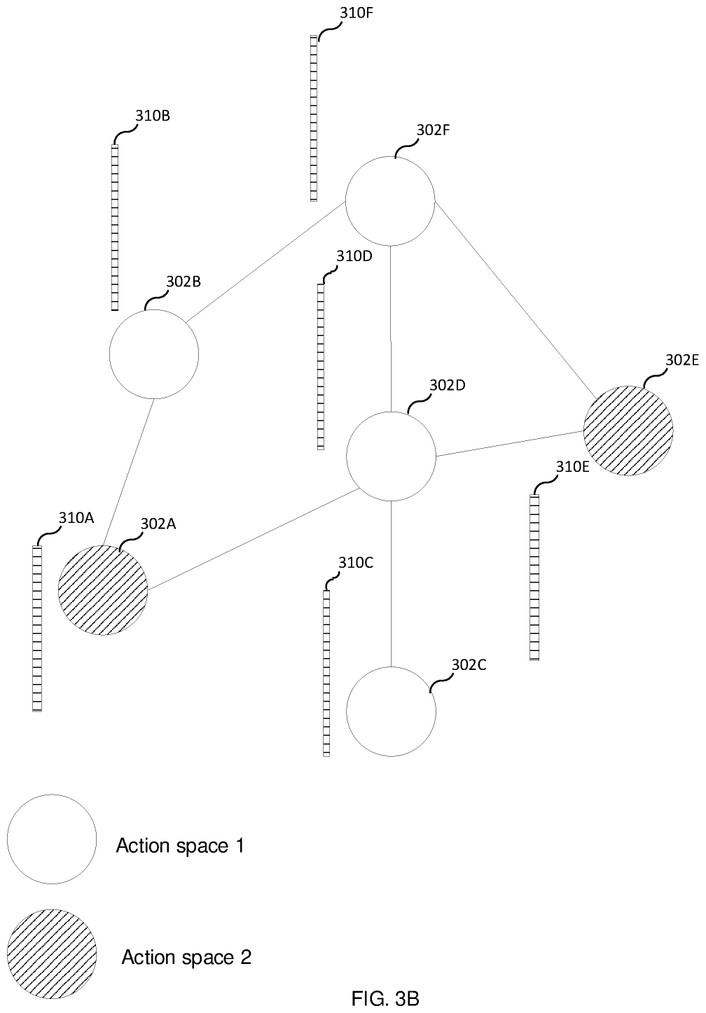

FIGS. 3A-B are block diagrams of a coordination scenario in a radio access network, according to some embodiments. FIG. 3 illustrates a topology with multiple network nodes, or agents (302A-F). Agents 302B, 302C, 302D, and 302F have action space 1, and agents 302A and 302E have action space 2. All agents have a single objective. An example of this scenario would be: (1) The objective is to lower power consumption of the network; (2) The agents are a set of agents that can fulfill a reduced power consumption consisting of: a set of agents controlling the emitted power of a set of antennas (one agent per antenna), and an agent controlling the amount of compute resources allocated to a virtual MME. The action spaces of the agents are, respectively, a set of possible power levels for the antenna and a set of compute resource configurations for the virtual MME.

According to some embodiments, a network topology comprising a graph is provided as described above. A cyclic graph CG=(V,E) is provided where each agent is a vertex and where an edge is added between two agents that can influence each other. For each pair of connected agents i and j, a value function qᵢⱼ(aⱼ, aⱼ, . . . ) returns a value for each pair of actions taken by these two agents. With this setup, coordination across all the agents is achieved by maximizing the sum of the value functions across the graph:

$${a}^{*} = {argmax}_{a ∈ ( {A}_{1} , … , {A}_{n} )} {\sum }_{i , j} {q}_{i , j} ( {a}_{i} , {a}_{j} ) .$$

Over large graphs, the combinatorial complexity of finding the optimum set of actions across all agents can be very high. A message passing algorithm, such as described in [4], can be used to achieve this goal as shown in Table 1 below.

TABLE 1
Pseudo-code of centralized max-plus algorithm

```
Centralized max-plus algorithm for CG = (V, E)
initialize μⱼᵢ = μᵢⱼ = 0 for (i, j) ∈ E, gᵢ = 0 for i ∈ V and m = −∞
while fixed-point = false and deadline to sent action has not yet arrived do
  // run one iteration
  fixed-point = true
  for every agent i do
    for all neighbors j = Γ(i) do
      send j message μᵢⱼ(aⱼ) = maxₐᵢ {fᵢ(aᵢ) + fᵢⱼ(aᵢ, aⱼ) + Σ_{k∈Γ( i)\j} μₖᵢ (aᵢ)} + cᵢⱼ
      if μᵢⱼ(aⱼ) differs from previous message by a small threshold then fixed-point = false
      determine gᵢ(aᵢ) = fᵢ(aᵢ) + Σ_{j∈Γ( i)} μⱼᵢ(aᵢ) and a′ᵢ = argmaxₐᵢ gᵢ(aᵢ)
  if use anytime extension then
      if u(a′ᵢ ) > m then
        (a*ᵢ) = (a′ᵢ) and m = u((a′ᵢ ))
  else
      (a*ᵢ) = (a′ᵢ)
return (a*ᵢ)
```

In the above, fᵢ and fᵢⱼ are payoff functions, and cᵢⱼ is a normalization value.

The algorithm uses the concept of message-passing that can be described using the following steps:

(1) Each agent i computes a message, μᵢⱼ(aⱼ), for all its neighbors, corresponding to the maximum payoff that agent i can achieve if its neighbor j takes action aⱼ.

(2) The agent sends the messages to its neighbors and receives messages from the neighbor.

(3) It updates the value of its outgoing messages based on the local value functions, qᵢⱼ, and the incoming messages μⱼᵢ.

(4) The agents keep sending messages and receiving messages until the value of its outgoing and incoming messages converges.

FIG. 3A illustrates a set of action spaces for pairs of agents (308A-D) before the message passing, and FIG. 3B illustrates a set of optimal actions (310A-F) for each respective agent (302A-F).

### Multiple Agents/Multiple Action Spaces/Multiple Objectives

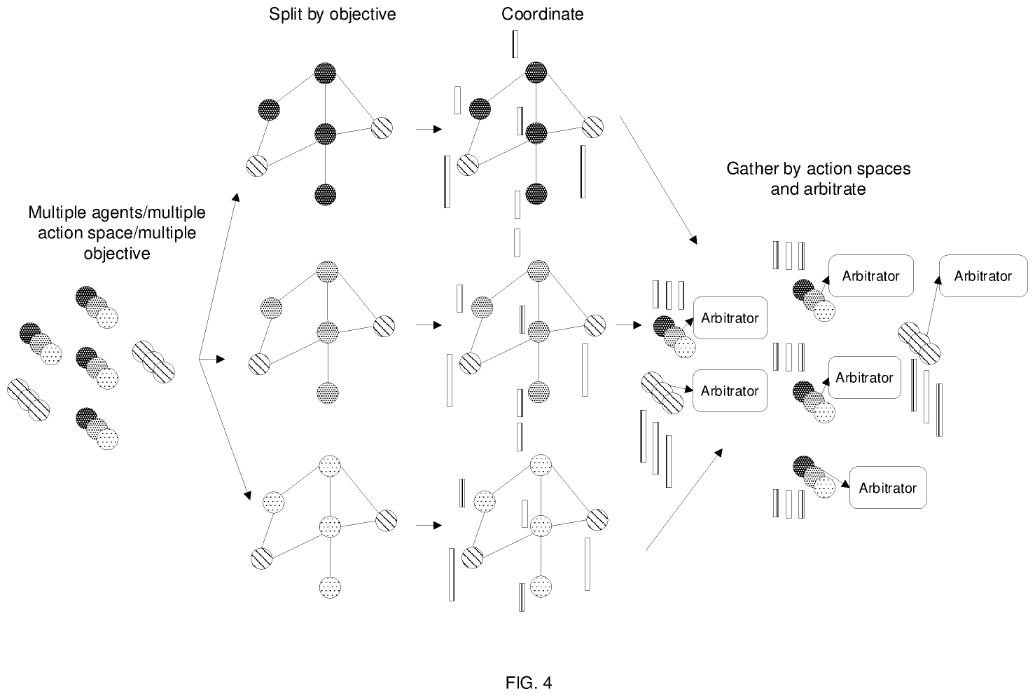

FIG. 4 is a block diagram of a coordination scenario in a radio access network, according to some embodiments. This scenario is a combination of the two previous scenarios, where we have multiple agents, multiple action spaces and multiple objectives. Some agents might be collaborating on the same objective, some other might be sharing the same action space.

An example of such scenario can be described as follows: the objectives are to lower power consumption, and improve the coverage and capacity of the network; the agents are (i) a set of agents controlling the emitted power of a set of antennas (one agent per antenna) to minimize energy consumption, (2) a set of agents controlling the tilt of a set of antennas (one agent per antenna) to maximize throughput, and (3) a set of agents controlling the tilt of a set on antennas (one agent per antenna) to maximize coverage; and the actions spaces for the agents are (respectively): (i) a set of possible power levels for the antennas, (ii) a set of possible tilt configurations for the antennas, and (iii) the same set of possible tilt configurations for the same antennas.

The methods disclosed herein offer a principled way to coordinate all those agents and find the joint actions that will maximize the overall value of the network. Solving this problem consists in successively applying the algorithm for the two previous scenarios.

Identify the number of objectives: first, group the agents by the objective they are trying to optimize. In the example above we would have three groups: agents aiming at controlling power, agents aiming at maximizing throughput, agents aiming at maximizing coverage.

For each objective construct a coordination graph: the set of agents collaborating toward the same objectives can be identified, and a coordination graph may be constructed similarly as described above. The best joint values are computed for those agents. Contrary to the previous problem where the best actions were found, in this scenario the best value vectors are determined. At the end of the message passing procedure, the value vector for each agent is:

$${q}_{i} ( {a}_{i} ) = {\sum }_{j ∈ N ( i )} {μ}_{ji} ( {a}_{i} ) .$$

Identify the shared action spaces: for a given action space, there may be several agents. In the example above there is tilt control for each antenna which is shared by the throughput maximizing agent and the coverage maximizing agent. Using the individual value function computed in the previous step, the values can be aggregated using the arbitration technique proposed in the previous section.

This approach is decomposing the problem into multiple instances of the two problems above. The instances of multiple agent/single objective are first solved. Then using the result from this first step, all the instances of multiple agents/multiple objectives/single action are solved.

According to some embodiments, agents may exchange information between each other in the form of value functions. One or more of the following may be standardized across agents, e.g., among different operators and vendors: (a) the format of the value function shipped by agents to be able to participate in the coordination, (b) the way agents communicate their value functions and whether it is mandatory to communicate one, (c) the format of the messages exchanged during the decentralized computation of the coordination algorithm and the interface to send and receive such messages, and/or (d) the format of the messages to be sent to the arbitration function during the centralized computation.

Value functions for pair of agents from different vendors can be used for vendors to provide compatible products without disclosing the core intelligence of their agents. In addition, the methods disclosed herein provide a way for vendors to encourage relationships with other vendors. For example, one vendor could specifically tune the value function of their product so that it is more compatible with other vendors that vendor wishes to collaborate with.

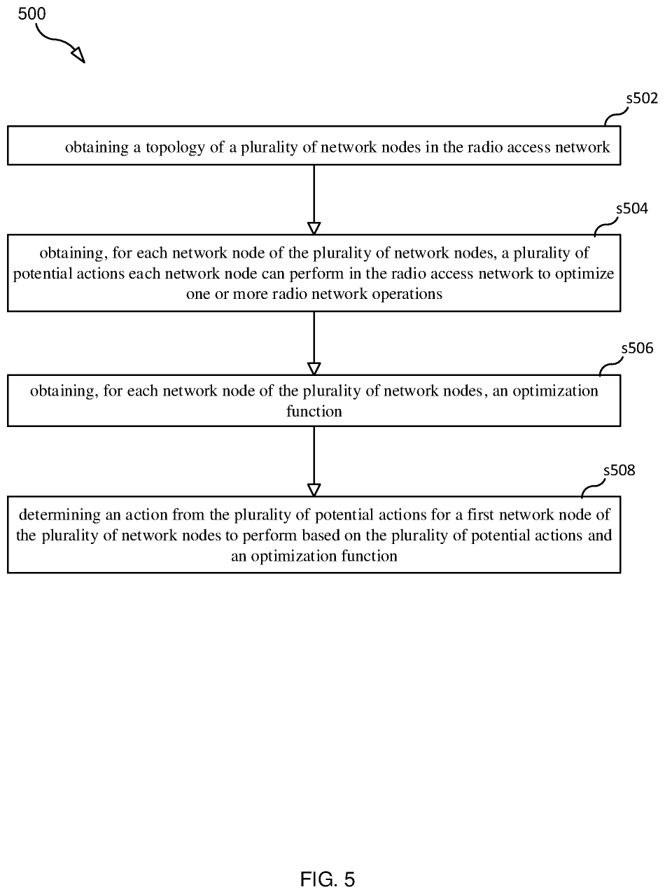

FIG. 5 illustrates a method, according to some embodiments. In some embodiments, method 500 is a computer-implemented method for coordinating nodes in a radio access network to optimize radio network operations.

Step s502 of the method includes obtaining a topology of a plurality of network nodes in the radio access network. The topology may be the coordination graph as described above.

Step s504 of the method includes, obtaining, for each network node of the plurality of network nodes, a plurality of potential actions each network node can perform in the radio access network to optimize one or more radio network operations.

Step s506 of the method includes obtaining, for each network node of the plurality of network nodes, an optimization function. In some embodiments, the optimization function is the value function as described herein.

Step s508 of the method includes determining an action from the plurality of potential actions for a first network node of the plurality of network nodes to perform based on the plurality of potential actions and an optimization function.

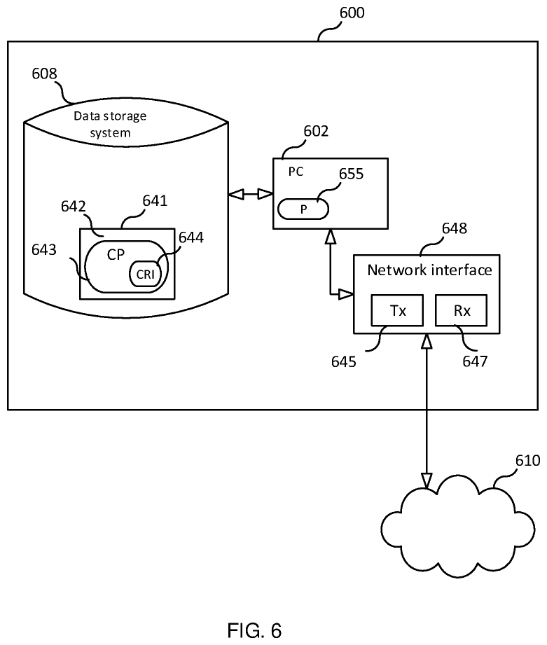

FIG. 6 is a block diagram of a computing device 600 according to some embodiments. In some embodiments, computing device 600 may comprise one or more of the components of a network node or agent. As shown in FIG. 6, the device may comprise: processing circuitry (PC) 602, which may include one or more processors (P) 655 (e.g., one or more general purpose microprocessors and/or one or more other processors, such as an application specific integrated circuit (ASIC), field-programmable gate arrays (FPGAs), and the like); communication circuitry 648, comprising a transmitter (Tx) 645 and a receiver (Rx) 647 for enabling the device to transmit data and receive data (e.g., wirelessly transmit/receive data) over network 610; and a local storage unit (a.k.a., “data storage system”) 608, which may include one or more non-volatile storage devices and/or one or more volatile storage devices. In embodiments where PC 602 includes a programmable processor, a computer program product (CPP) 641 may be provided. CPP 641 includes a computer readable medium (CRM) 642 storing a computer program (CP) 643 comprising computer readable instructions (CRI) 644. CRM 642 may be a non-transitory computer readable medium, such as, magnetic media (e.g., a hard disk), optical media, memory devices (e.g., random access memory, flash memory), and the like. In some embodiments, the CRI 644 of computer program 643 is configured such that when executed by PC 602, the CRI causes the apparatus to perform steps described herein (e.g., steps described herein with reference to the flow charts). In other embodiments, the apparatus may be configured to perform steps described herein without the need for code. That is, for example, PC 602 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above described embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### REFERENCES

[1] PCT/IB2020/061668, “Decentralized coordinated reinforcement learning for optimizing radio access networks,” filed on Dec. 9, 2020.
[2] Rosenblatt, Julio K. “Utility fusion: Map-based planning in a behavior-based system.” Field and Service Robotics. Springer, London, 1988.
[3] Bouton, M., Julian, K. D., Nakhaei, A., Fujimura, K., & Kochenderfer, M. J. (2019). Decomposition methods with deep corrections for reinforcement learning. Autonomous Agents and Multi-Agent Systems, 33 (3), 330-352.
[4] Kok, J. R., & Vlassis, N. (2006). Collaborative multiagent reinforcement learning by payoff propagation. Journal of Machine Learning Research, 7, 1789-1828.

1. A computer-implemented method for coordinating nodes in a radio access network to optimize radio network operations, the method comprising:
obtaining a topology of a plurality of network nodes in the radio access network;
obtaining, for each network node of the plurality of network nodes, a plurality of potential actions each network node can perform in the radio access network to optimize one or more radio network operations;
obtaining, for each network node of the plurality of network nodes, an optimization function; and
determining an action from the plurality of potential actions for a first network node of the plurality of network nodes to perform based on the plurality of potential actions and an optimization function.

2. The method of claim 1, wherein the optimization function and the plurality of potential actions are the same for each network node of the plurality of network nodes.

3. The method of claim 2, wherein the determining the action comprises determining that the action maximizes an optimization function of the first network node.

4. The method of claim 1, wherein the plurality of potential actions are the same for each network node of the plurality of network nodes and wherein an optimization function of the first network node is different than an optimization function of a second network node of the plurality of network nodes.

5. The method of claim 4, wherein the determining comprises:
generating an aggregated optimization function using each optimization function from each network node; and
determining that the action maximizes the aggregated optimization function.

6. The method of claim 5, wherein the aggregated optimization function comprises at least one of: a sum of each optimization function from each network node, a weighted sum of each optimization function from each network node, a parametric function of each optimization function from each network node using a learned parameter, or a combination thereof.

7. The method of claim 1, wherein the optimization function is the same for each network node of the plurality of network nodes and wherein a first plurality of potential actions of the first network node is different than a second plurality of potential actions of a second network node of the plurality of network nodes.

8. The method of claim 7, wherein the topology is a coordination graph comprising a plurality of vertices corresponding to a respective network node of the plurality of network nodes and at least one edge connecting two of the vertices of the plurality of vertices, wherein each edge in the coordination graph indicates that an action of a network node corresponding to a first vertex connected to the edge may interfere with an action of a network node corresponding to a second vertex also connected to the edge.

9. The method of claim 8, wherein a first vertex corresponds to the first network node and a second vertex corresponds to the second network node, and a first edge connects the first vertex to the second vertex.

10. The method of claim 9, wherein a first optimization function of the first network node returns a value for each pair of actions taken by the first network node and the second network node.

11. The method of claim 7, further comprising:
for a respective network node of the plurality of network nodes:
(i) identifying any neighboring network nodes to the respective network node based on the coordination graph,
(ii) for each neighboring network node identified in step, computing a first message corresponding to a first maximum payoff that the respective network node can achieve if the neighboring network node takes a specified action,
(iii) transmitting the first message towards each neighboring network node, and
(iv) receiving, from each neighboring network node, a second message, indicating a second maximum payoff that the neighboring network node can achieve if the respective network node takes a second specified action.

12. The method of claim 11, further comprising;
for each respective network node of the plurality of network nodes:
(v) for each neighboring network node, computing a third message corresponding to an updated first maximum payoff that the respective network node can achieve if the neighboring network node takes a third specified action based on the second maximum payoff indicated in the second message,
(vi) transmitting the third message towards each neighboring network node, and
(vii) receiving, from each neighboring network node, a fourth message,
indicating an updated second maximum payoff that the neighboring network node can achieve if the respective network node takes a fourth specified action.

13. The method of claim 12, further comprising repeating steps (i)-(vii) until convergence of the first maximum payoff and the second maximum payoff or a predetermined number of times.

14. The method of claim 1, wherein a first optimization function of the first network node is different than a second optimization function of a second network node of the plurality of network nodes and wherein a first plurality of potential actions of the first network node is different than a second plurality of potential actions of the second network node.

15. The method of claim 14, further comprising:
identifying a first set of one or more network nodes of the plurality of network nodes having the first optimization function;
constructing, using the topology, a first coordination graph comprising a plurality of vertices corresponding to a respective network node of the first set of one or more network nodes and at least one edge connecting two of the vertices of the plurality of vertices, wherein each edge in the first coordination graph indicates that an action of a network node corresponding to a first vertex may interfere with an action of a network node corresponding to a second vertex;
identifying a second set of one or more network nodes of the plurality of network nodes having the second optimization function; and
constructing, using the topology, a second coordination graph comprising a plurality of vertices corresponding to a respective network node of the second set of one or more network nodes and at least one edge connecting two of the vertices of the plurality of vertices, wherein each edge in the second coordination graph indicates that an action of a network node corresponding to a first vertex may interfere with an action of a network node corresponding to a second vertex.

16. The method of claim 15, further comprising:
computing, for each edge in the first coordination graph, a joint optimization function; and
computing, for each edge in the second coordination graph, a joint optimization function.

17. The method of claim 16, further comprising:
generating an aggregated optimization function based on a plurality of joint optimization functions from at least one of the first coordination graph and the second coordination graph; and
determining an action from the plurality of potential actions that maximizes the aggregated optimization function.

18. (canceled)

19. The method of claim 1, wherein the one or more radio network operations comprise one or more of: reducing energy consumption, limiting transmission power of an antenna, downscaling a network function, turning on indoor sites on a facility, incrementing or decrementing a network parameter, adjusting a key performance indicator of the network, achieving a target signal-to-interference-plus-noise ratio value for all user equipment connected to an antenna, improving coverage for user equipment served by an antenna, maximizing throughput, or maximizing coverage.

20. (canceled)

21. A device for coordinating nodes in a radio access network to optimize radio network operations, wherein the device is adapted to:
obtain a topology of a plurality of network nodes in the radio access network;
obtain, for each network node of the plurality of network nodes, a plurality of potential actions each network node can perform in the radio access network to optimize one or more radio network operations;
obtain, for each network node of the plurality of network nodes, an optimization function; and
determine an action from the plurality of potential actions for a first network node of the plurality of network nodes to perform based on the plurality of potential actions and an optimization function.

22. (canceled)

23. A computer program comprising instructions which when executed by processing circuitry of a computing device causes the device to:
obtain a topology of a plurality of network nodes in the radio access network;
obtain, for each network node of the plurality of network nodes, a plurality of potential actions each network node can perform in the radio access network to optimize one or more radio network operations;
obtain, for each network node of the plurality of network nodes, an optimization function; and
determine an action from the plurality of potential actions for a first network node of the plurality of network nodes to perform based on the plurality of potential actions and an optimization function.

24. (canceled)

25. (canceled)
